(19) United States
(12) Patent Application Publication
(10) Pub. No.: US 2017/0058995 A1
(43) Pub. Date: Mar. 2, 2017

(54) TRANSMISSION BELT

(71) Applicant: BANDO CHEMICAL INDUSTRIES, LTD., Kobe-shi (JP)

(72) Inventors: Sungjin Kim, Kobe-shi (JP); Sakae Umeda, Kobe-shi (JP)

(21) Appl. No.: 15/349,712

(22) Filed: Nov. 11, 2016

Related U.S. Application Data
(63) Continuation of application No. PCT/JP2015/001490, filed on Mar. 17, 2015.

(30) Foreign Application Priority Data
May 14, 2014 (JP) 2014-100233

(51) Int. Cl. F16G 5/20; F16G 5/08; B29C 43/00; B29C 43/02; B29D 29/10; B29C 43/18

(52) U.S. Cl. CPC F16G 5/20; B29D 29/103; B29C 43/183; B29C 43/003; B29C 43/021; F16G 5/08; B29K 2995/0092; B29K 2509/00

(57) ABSTRACT

A friction transmission belt includes a belt body looped over a pulley, and transmitting power. The belt body includes a rubber composition in which at least one of montmorillonite and magnesium carbonate is mixed. The friction transmission belt includes a fabric layer coating at least a surface, of the belt body, making contact with the pulley. The fabric layer has a portion making contact with at least one of the montmorillonite and the magnesium carbonate mixed into the rubber composition.

### CROSS-REFERENCE TO RELATED APPLICATIONS

This is a continuation of International Application No. JP2015/001490 filed on Mar. 17, 2015, which claims priority to Japanese Patent Application No. 2014-100233 filed on May 14, 2014. The entire disclosures of these applications are incorporated by reference herein.

### BACKGROUND

Power transmission belts, typically such belts as friction transmission belts, are used as a means to transmit rotational power of engines and motors used for mechanical systems and cars. When such a power transmission belt is wet, belt slip increases, followed by occurrence of stick-slip and the resulting abnormal noise. Moreover, the increase in belt slip causes a decrease in transmission performance, resulting in lower fuel efficiency.

To address the problem, PATENT DOCUMENT 1 (WO2010/098091) discloses a friction transmission belt whose belt body is formed of a rubber composition into which a layered silicate is mixed.

### SUMMARY

The friction transmission belt cited in PATENT DOCUMENT 1 is effective in curbing, to some extent, occurrence of abnormal noise and reduction in transmission performance when the friction transmission belt is wet; however, users are expecting higher performance from friction transmission belts, and asking for their further improvement. The present disclosure intends to provide a friction transmission belt having high transmission performance under a wet condition.

A friction transmission belt of the present disclosure is looped over a pulley and transmits power. The friction transmission belt includes: a belt body made of a rubber composition in which at least one of montmorillonite or magnesium carbonate is mixed; and a fabric layer configured to coat at least a surface, of the belt body, making contact with the pulley, wherein the fabric layer has a portion making contact with at least one of the montmorillonite or the magnesium carbonate mixed into the rubber composition.

The fabric layer may be a woven fabric or a knitted fabric, and the fabric layer may have a portion embedded in the rubber composition included in the belt body.

Moreover, the woven fabric or the knitted fabric may absorb water.

Furthermore, the friction transmission belt of the present disclosure may be made of a product including a rubber layer for forming the friction transmission belt and a fabric wrapped over a surface of the rubber layer, the product being pressed against a mold and simultaneously crosslinked to be the friction transmission belt, and the mold has a ribbed part to shape the surface of the belt body making contact with the pulley.

The friction transmission belt of the present disclosure has the fabric layer making contact with the montmorillonite and/or the magnesium carbonate. Such a feature allows the montmorillonite or the magnesium carbonate to further absorb water which the fabric layer has absorbed, contributing to effectively curbing deterioration in the transmission performance of the friction transmission belt under a wet condition. In other words, the feature contributes to improvement in the transmission performance under a wet condition.

### BRIEF DESCRIPTION OF THE DRAWINGS

FIG. 1 is a perspective view schematically illustrating a V-ribbed belt according to an embodiment of the present disclosure.

FIG. 2 is a magnified cross-sectional view illustrating a region in a vicinity of a pulley contact surface of the V-ribbed belt in FIG. 1.

FIG. 3 is an illustration showing how to manufacture the V-ribbed belt in FIG. 1.

FIG. 4 is an illustration showing, following FIG. 3, how to manufacture the V-ribbed belt in FIG. 1.

FIG. 5 illustrates a layout of pulleys of a belt running test machine used in a transmission performance test under a wet condition.

FIG. 6 is an illustration showing a result of the transmission performance test of the V-ribbed belt under a wet condition.

### DETAILED DESCRIPTION

Described below in detail are embodiments of the present disclosure with reference to the drawings.

### (V-Ribbed Belt)

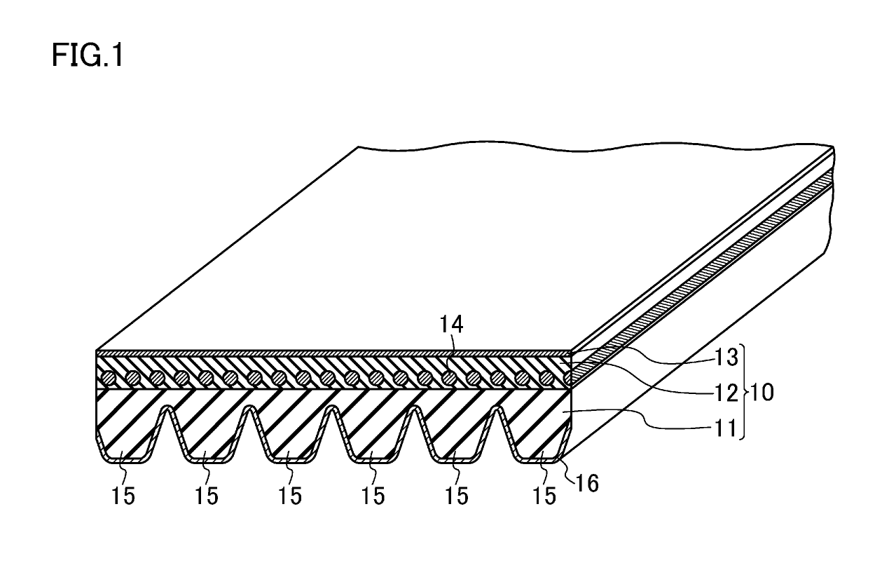

FIG. 1 illustrates an example of a V-ribbed belt (a friction transmission belt) according to an embodiment of the present disclosure. This V-ribbed belt B is used for an accessory drive belt transmission system provided in an automotive engine compartment, for example. The V-ribbed belt B has a belt circumferential length ranging from 700 mm to 3,000 mm, a belt width ranging from 10 mm to 36 mm, and a belt thickness ranging from 4.0 mm to 5.0 mm.

The V-ribbed belt B includes a V-ribbed belt body 10 formed of such three layers as: a compressed rubber layer 11 to an inner periphery of the V-ribbed belt B; an adhesive rubber layer 12; and a back surface rubber layer 13 to an outer periphery of the V-ribbed belt B. The adhesive rubber layer 12 is sandwiched between the compressed rubber layer 11 and the back surface rubber layer 13. A cord 14, embedded in the adhesive rubber layer 12, is helical with a pitch along the belt width.

The compressed rubber layer 11 has multiple V-shaped ribs 15 protruding toward the inner periphery of the belt. Each of the V-shaped ribs 15 is a pulley contact portion. The V-shaped ribs 15 are arranged in parallel to one another along the belt width. Each V-shaped rib 15 is shaped into a ridge extending along the belt length and having a substantially inverted triangular cross-section. Each V-shaped rib 15 has a height ranging from 2.0 mm to 3.0 mm, for example. A width between the base ends of the V-shaped rib 15 ranges from 1.0 mm to 3.6 mm, for example. Moreover, there are 3 to 6 V-shaped ribs 15, for example (in FIG. 1, there are six ribs).

Moreover, a surface (i.e. a surface in contact with a pulley), of the V-ribbed belt body 10, to the V-shaped ribs 15 is provided with a fabric layer 16.

The fabric layer 16 is knitted out of such yarns as: (i) woolly-processed yarns made of polyamide fibers, polyester fibers, cotton, nylon fibers, and aramid fibers with false-twisted (woolly processed); or (ii) covered yarns each made of a polyurethanestrerch yarn, serving as a core yarn, covered with a covering yarn made of, for example, nylon. The fabric layer 16 has a thickness ranging from 0.1 mm to 0.8 mm, for example. Alternatively, a woven fabric may also be used instead of the knitted fabric.

Furthermore, the compressed rubber layer 11 is formed of a rubber composition into which a water absorbent compound is mixed. Examples of the water absorbent compound may include at least one of montmorillonite and magnesium carbonate.

The montmorillonite may beneficially have a particle size ranging from 0.05 μm to 120 μm, and more beneficially, from 0.5 μm to 80 μm. Moreover, the amount of the montmorillonite mixed into 100 parts by mass of a material rubber may range from 10 parts by mass to 50 parts by mass, beneficially from 10 parts by mass to 40 parts by mass, and more beneficially from 10 parts by mass to 30 parts by mass. The magnesium carbonate may be the same in particle size and amount to be mixed into the material rubber as the montmorillonite.

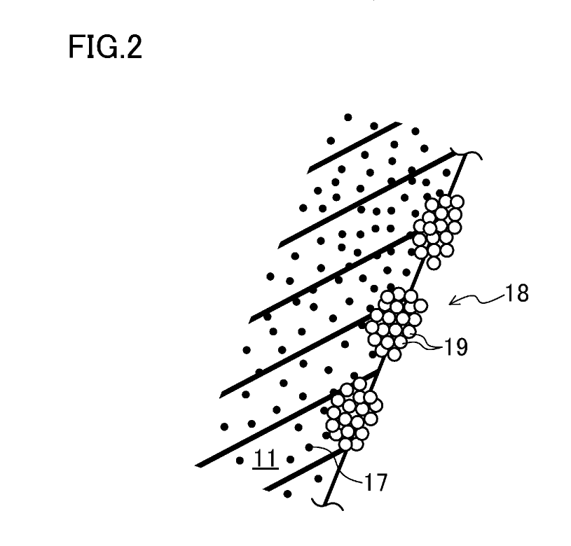

FIG. 2 illustrates the fabric layer 16 and a water absorbent compound 17. FIG. 2 is a magnified cross-sectional view illustrating a region in a vicinity of a surface, to the V-shaped ribs 15, of the compressed rubber layer 11 of the V-ribbed belt body 10. A yarn 18 constituting the fabric layer 16 is embedded in the surface of the compressed rubber layer 11 to the V-shaped ribs 15. The yarn 18 is made of multiple fibers 19. Moreover, the water absorbent compound 17 is mixed into the compressed rubber layer 11. Examples of the water absorbent compound 17 include montmorillonite and/or magnesium carbonate. Furthermore, the water absorbent compound 17 and the fibers 19 of the fabric layer 16 make contact with each other in the vicinity of the surface of the compressed rubber layer 11.

Such a configuration improves water absorbency of the V-ribbed belt B. Specifically, when the V-ribbed belt is wet, the water is absorbed into the water absorbent compound 17 mixed into the compressed rubber layer 11, as well as into the fabric layer 16. Here, because the fibers 19 of the fabric layer 16 and the water absorbent compound 17 make contact with each other in the vicinity of the surface of the compressed rubber layer 11, the water absorbed into the fabric layer 16 is further absorbed effectively into the water absorbent compound 17. This combined use of the fabric layer 16 and the water absorbent compound 17 may achieve high water absorbency, contributing to improvement in transmission performance of the V-ribbed belt B under a wet condition.

Note that the compressed rubber layer 11 is formed of a rubber composition. The rubber composition is made of an uncrosslinked rubber composition including a material rubber mixed and kneaded together with various kinds of compounding ingredients. The uncrosslinked rubber composition is then heated and pressurized, and crosslinked by a crosslinker to become the rubber composition.

The material rubber in the rubber composition forming the compressed rubber layer 11 includes ethylene-α-olefin elastomer. Examples of the ethylene-α-olefin elastomer include ethylene-propylene-diene monomer rubber (EPDM), ethylene-propylene copolymer (EPM), ethylene-butene copolymer (EBM), and ethylene-octene copolymer (EOM). The ethylene-α-olefin elastomer included in the material rubber may be made of a single kind of elastomer. Alternatively, the ethylene-α-olefin elastomer may be made of multiple kinds of elastomer blended together. The ethylene-α-olefin elastomer has an ethylene content ranging from 50% by mass to 80% by mass, for example.

The material rubber has an ethylene-α-olefin elastomer content of, beneficially, 60% by mass or higher, more beneficially, 80% by mass or higher, and most beneficially, 100% by mass. That is, it is most recommended that the material rubber may be made of ethylene-α-olefin elastomer alone. Examples of other rubbers included in the material rubber are chloroprene rubber (CR), chlorosulfonated polyethylene rubber (CSM), and hydrogenated acrylonitrile rubber (H-NBR).

Examples of compounding ingredients, other than the water absorbent compound 17, mixed into the rubber composition forming the compressed rubber layer 11 include a reinforcing material such as carbon black, a vulcanization accelerator, a crosslinker, an antioxidant, and a softener.

Examples of the carbon black as the reinforcing material include: channel black; furnace black such as SAF, ISAF, N-339, HAF, N-351, MAF, FEF, SRF, GPF, ECF, and N-234; thermal black such as FT and MT; and acetylene black. Silica may be used as the stiffener. The stiffener may be made of a single kind of stiffener. Alternatively, the stiffener may be made of multiple kinds of stiffener. The amount of the reinforcing material mixed into 100 parts by mass of the material rubber beneficially ranges from 30 parts by mass to 80 parts by mass in view of achieving an excellent balance between wear resistance and flex resistance.

Examples of the vulcanization accelerator include: metal oxide such as magnesium oxide and zinc oxide; metal carbonate; fatty acid such as stearic acid; and a derivative of the fatty acid. The vulcanization accelerator may be made of a single kind of vulcanization accelerator. Alternatively, the vulcanization accelerator may be made of multiple kinds of vulcanization accelerator. The amount of the vulcanization accelerator mixed into 100 parts by mass of the material rubber beneficially ranges from 0.5 parts by mass to 8 parts by mass, for example.

Examples of the crosslinker include sulfur and organic peroxide. The crosslinker may include sulfur. Alternatively, the crosslinker may also include organic peroxide. Furthermore, the crosslinker may also include a combination of sulfur and organic peroxide. When made of sulfur, the crosslinker mixed into 100 parts by mass of the material rubber beneficially ranges in amount from 0.5 parts by mass to 4.0 parts by mass. When made of organic peroxide, the crosslinker mixed with 100 parts by mass of the material rubber ranges in amount from 0.5 parts by mass to 8 parts by mass, for example.

Examples of the antioxidant include amine-based antioxidant, quinoline-based antioxidant, hydroquinone derivative, phenol-based antioxidant, and phosphite-ester-based antioxidant. The antioxidant may be made of a single kind of antioxidant. Alternatively, the antioxidant may be made of multiple kinds of antioxidant. The amount of the antioxidant mixed into 100 parts by mass of the material rubber ranges from 0 parts by mass to 8 parts by mass, for example.

Examples of the softener include: petroleum-based softener; paraffinum-liquidum-based softener such as paraffin wax; and vegetable-oil-based softener such as castor oil, cottonseed oil, linseed oil, rapeseed oil, soybean oil, palm oil, coconut oil, peanut oil, sumach wax, rosin, and pine oil. The softener may be made of a single kind of softener. Alternatively, the softener may be made of multiple kinds of softener. The amount of the softener, other than the petroleum-based softener, mixed into 100 parts by mass of the material rubber beneficially ranges from 2 parts by mass to 30 parts by mass, for example.

### (Method for Manufacturing V-Ribbed Belt)

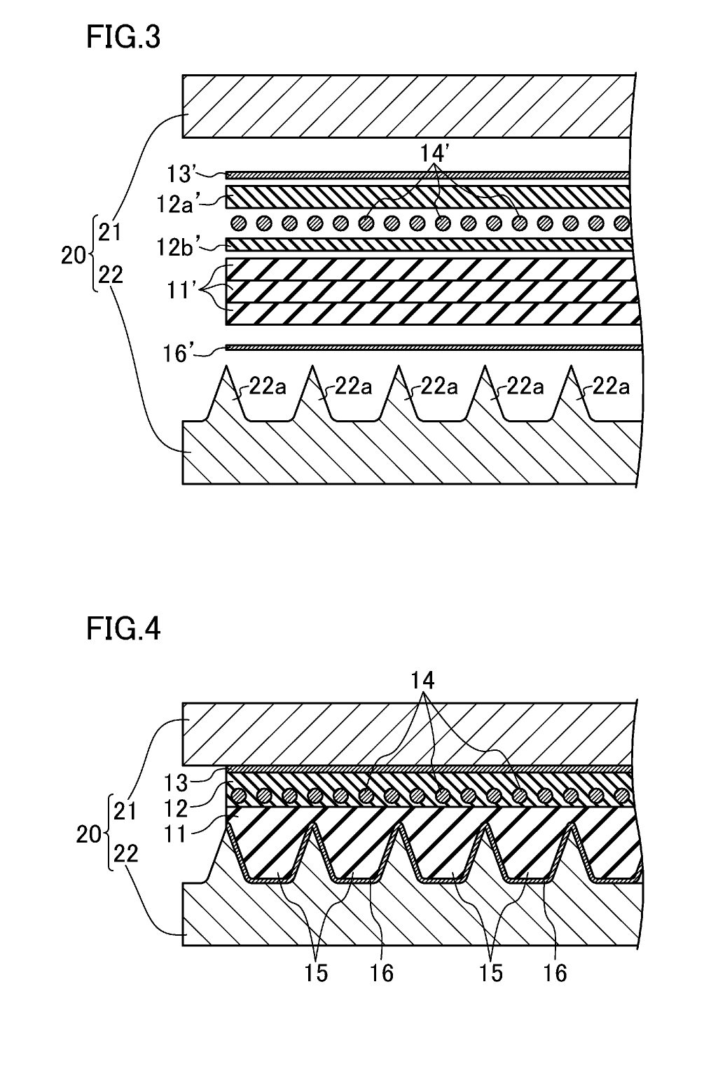

Described next is a method for manufacturing the V-ribbed belt B, with reference to FIGS. 3 and 4. Used here is a belt forming apparatus 20. The belt forming apparatus 20 includes a rubber sleeve mold 21 shaped into a cylinder, and a cylindrical outer mold 22 fitting to the rubber sleeve mold 21.

The rubber sleeve mold 21 is made of, for example, a flexible material such as acrylic rubber. Using a method such as sending water vapor of a high temperature from inside the rubber sleeve mold 21, the rubber sleeve mold 21 may be inflated radially outward and pressed against the cylindrical outer mold 22. The outer circumference face of the rubber sleeve mold 21 is shaped to provide, for example, a smooth face to the back surface of the V-ribbed belt B. The rubber sleeve mold 21 has an outer diameter ranging from 700 mm to 2,800 mm, a thickness ranging from 8 mm to 20 mm, and a height ranging from 500 mm to 1,000 mm, for example.

The cylindrical outer mold 22 is made of metal, for example. The inner circumference face of the cylindrical outer mold 22 is provided with ridges 22a extending in the circumferential direction and arranged in the height direction. The ridges 22a are substantially triangular in cross-section to form the V-shaped ribs 15 of the V-ribbed belt B. There are 140 of the ridges 22a arranged in the height direction, for example. The cylindrical outer mold 22 has, for example, an outer diameter ranging from 830 mm to 2,930 mm, an inner diameter (not including the ridges 22a) ranging from 730 mm to 2,830 mm, and a height ranging from 500 mm to 1,000 mm. Each of the ridges 22a has a height ranging from 2.0 mm to 2.5 mm, and a width ranging from 3.5 mm to 3.6 mm.

Materials of the belt are sequentially set to this belt forming apparatus 20. First, a cylindrical rubber sheet 13′ to be used as a back surface rubber layer 13 is fitted to the rubber sleeve mold 21. After that, a sheeted adhesive rubber ingredient 12a′ is wrapped over the cylindrical rubber sheet 13′. Then, twisted yarns 14′ are wound multiple times over the adhesive rubber ingredient 12a′ to extend in the circumferential direction. Here, the twisted yarns 14′ are wound to form a helical pattern having pitches in the height direction of the rubber sleeve mold 21. Next, a sheeted adhesive rubber ingredient 12b′ is wrapped over the twisted yarns 14′, and, furthermore, a sheeted compressed rubber ingredient 11′ is wrapped over the adhesive rubber ingredient 12b′. Here, the compressed rubber ingredient 11′ is made of a rubber composition in which the water absorbent compound 17 is mixed. Then, a cylindrical fabric 16′ is fitted onto the compressed rubber ingredient 11′. Here, as illustrated in FIG. 3, the rubber sheet 13′, the adhesive rubber ingredient 12a′, the twisted yarns 14′, the adhesive rubber ingredient 12b′, the compressed rubber ingredient 11′, and the fabric 16′ are stacked in the stated order from the rubber sleeve mold 21. Moreover, the cylindrical outer mold 22 is attached outward the belt materials.

Subsequently, with the cylindrical outer mold 22 attached to the rubber sleeve mold 21, water vapor at a high temperature is sent to the rubber sleeve mold 21, for example, to apply heat and pressure to the rubber sleeve mold 21. Thus, the rubber sleeve mold 21 is inflated and pressed against the cylindrical outer mold 22, and the belt materials are sandwiched between the rubber sleeve mold 21 and the cylindrical outer mold 22. At this time, for example, the belt materials have a temperature ranging from 150° C. to 180° C., and receives a pressure ranging from 0.5 MPa to 1.0 MPa in a radially outward direction. Hence, a crosslinking reaction progresses as the rubber compositions flow, and so does the adhesive reaction of the rubber compositions to the fabric 16′ and the twisted yarns 14′. Furthermore, the ridges 22a, provided to the inner circumference face of the cylindrical outer mold 22, form the V-shaped grooves between the V-shaped ribs 15. Here, the cylindrical outer mold 22 serves as a V-shaped rib 15 forming unit. As can be seen, this is how to form a V-ribbed belt slab (i.e. a belt body precursor).

Finally, the V-ribbed belt slab is cooled and removed from the belt forming apparatus 20. After that, the removed V-ribbed belt slab is sliced in rounds each having a width ranging from, for example, 10.68 mm to 28.48 mm. Each of the sliced rounds is turned inside out. This is how to obtain the V-ribbed belt B.

Note that, in this embodiment, the sheeted adhesive rubber ingredients 12a′ and 12b′ and the compressed rubber ingredient 11′ are wrapped over, and set to, the rubber sleeve mold 21. Instead, the sheeted adhesive rubber ingredients 12a′ and 12b′ and the compressed rubber ingredient 11′ may previously be shaped into a cylinder to be fitted on, and set to, the rubber sleeve mold 21.

Furthermore, as to the belt forming apparatus 20, the inner circumference face of the cylindrical outer mold 22 is explained to, but shall not be limited to, have the V-shaped grooves for forming the V-shaped ribs 15 of the V-ribbed belt B. For example, the outer circumference face of the rubber sleeve mold may have ridges for forming the V-shaped ribs 15 of the V-ribbed belt B, and the inner circumference face of the cylindrical outer mold 22 may have a smooth surface for forming the back surface of the V-ribbed belt B. In this case, the fabric 16′, the compressed rubber ingredient 11′, the adhesive rubber ingredient 12b′, the twisted yarns 14′, the adhesive rubber ingredient 12a′, and the rubber sheet 13′ are wrapped over the rubber sleeve mold 21 in the stated order.

Note that the described belt and manufacturing method are for, but shall not be limited to, a V-ribbed belt and a manufacturing method thereof. Examples of the belt and the manufacturing method include a flat belt and a V-belt, and methods of manufacturing the flat belt and V-belt.

### Examples

Prepared are rubber compositions 1 to 3 below. Table 1 also shows details of the rubber compositions.

### (Rubber Composition)

<Rubber Composition 1>

An uncrosslinked rubber composition was prepared as a rubber composition 1. In the preparation of the uncrosslinked rubber composition, the compounding ingredients below were mixed and kneaded together by an internal mixer for approximately five minutes with 100 parts by mass of EPDM (manufactured by Mitsui Chemicals Inc. under the trade name of EPT 3045) used as a material rubber: 60 parts by mass of HAF carbon black (manufactured by Tokai Carbon Co., Ltd. under the trade name of SEAST SO); 30 parts by mass of montmorillonite (manufactured by Hojun Co., Ltd. under the trade name of BENGEL A having a swelling volume of 46 ml/2 g and a cation-exchange capacity of 94 meg/100 g); 5 parts by mass of zinc oxide (manufactured by Sakai Chemical Industry Co., Ltd., under the trade name of Zinc Oxide No. 2); 2 parts by mass of antioxidant (manufactured by Ouchi Shinko Chemical Industrial Co., Ltd., under the trade name of NOCRAC MB); 10 parts by mass of paraffinic oil (manufactured by Idemitsu Kosan Co., Ltd. under the name of Diana Process Oil PS-90); 2.3 parts by mass of sulfur (manufactured by Hosoi Chemical Industry Co., Ltd. under the trade name of Oil Sulfur); 1.4 parts by mass of vulcanization accelerator (manufactured by Sanshin Chemical Industry Co., Ltd. under the trade name of TET, EZ, and MSA); and 30 parts by mass of short fibers (manufactured by Asahi Kasei Corporation under the trade name of Leona 66 having a fiber length of 1 mm).

<Rubber Composition 2>

An uncrosslinked rubber composition was prepared as a rubber composition 2. The rubber composition 2 was the same in composition as the rubber composition 1 except that 50 parts by mass of montmorillonite was mixed into 100 parts by mass of the material rubber.

<Rubber Composition 3>

An uncrosslinked rubber composition was prepared as a rubber composition 3. The rubber composition 3 was the same in composition as the rubber composition 1 except that no montmorillonite was mixed; that is, 0 parts by mass of montmorillonite was mixed with 100 parts by mass of the material rubber.

TABLE 1

| | | Rubber Composition | | |
|---|---|---|---|---|
| | | 1 | 2 | 3 |
| EPDM | Manufactured by Mitsui Chemicals Inc. under | 100 | 100 | 100 |
| | the trade name of EPT 3045 | | | |
| HAF Carbon Black | Manufactured by Tokai Carbon Co., Ltd. under | 60 | 60 | 60 |
| | the trade name of SEAST SO | | | |
| Montmorillonite | Manufactured by Hojun Co., Ltd. under the | 30 | 50 | 0 |
| | trade name of BENGEL A | | | |
| Zinc Oxide | Manufactured by Sakai Chemical Industry Co., | 5 | 5 | 5 |
| | Ltd., under the trade name of Zinc Oxide No. 2 | | | |
| Antioxidant | Manufactured by Ouchi Shinko Chemical | 2 | 2 | 2 |
| | Industrial Co., Ltd., under the trade name of | | | |
| | NOCRAC MB | | | |
| Paraffinic oil | Manufactured by Idemitsu Kosan Co., Ltd. | 10 | 10 | 10 |
| | under the name of Diana Process Oil PS-90 | | | |
| Sulfur | Manufactured by Hosoi Chemical Industry Co., | 2.3 | 2.3 | 2.3 |
| | Ltd. under the trade name of Oil Sulfur | | | |
| Vulcanization | Manufactured by Sanshin Chemical Industry | 1.4 | 1.4 | 1.4 |
| Accelerator | Co., Ltd. under the trade name of TET, EZ, and | | | |
| | MSA | | | |
| Nylon Short | Manufactured by Asahi Kasei Corporation under | 30 | 30 | 30 |
| Fiber | the trade name of Leona 66 having a fiber | | | |
| | length of 1 mm | | | |

### (Fabric Layer)

The fabric layer 16 for use in coating a surface of the V-shaped ribs 15 is a plain-knitted fabric. The yarn structure of the fabric layer 16 is R22/78-52. Specifically, the yarns for the fabric layer 16 are 22 denier (24.4 dtex) of polyurethane elastic yarns covered with yarns made of nylon 6. Each of the covering yarns has 52 filaments and a yarn size of 78 denier (86.6 dtx).

Furthermore, a resorcin formalin latex (RFL) treatment is provided to the knitted fabric of the fabric layer 16. In the treatment, fibers included in the yarns are coated with RFL; however, not all the fibers adhere to each other, and gaps between the fibers cause a capillary action, allowing the fibers to absorb water.

### (V-Ribbed Belt)

A V-ribbed belt including the compressed rubber layer 11 was tested as Example 1, Example 2, and Comparative Example. In Example 1, Example 2, and Comparative Example, the rubber composition 1, rubber composition 2, and rubber composition 3 are respectively used to form the compressed rubber layer 11. The fabric layer 16 is the above knitted fabric.

In each V-ribbed belt, an adhesive rubber layer and a back surface rubber layer are formed of a rubber composition including another EPDM, and a cord is formed of a twisted yarn made of polyethylene terephthalate (PET) fibers. The V-ribbed belt has six ribs, and a belt circumferential length of 1,200 mm, a belt width of 21.36 mm, and a belt thickness of 4.3 mm.

### (Methods for Tests and Evaluations)

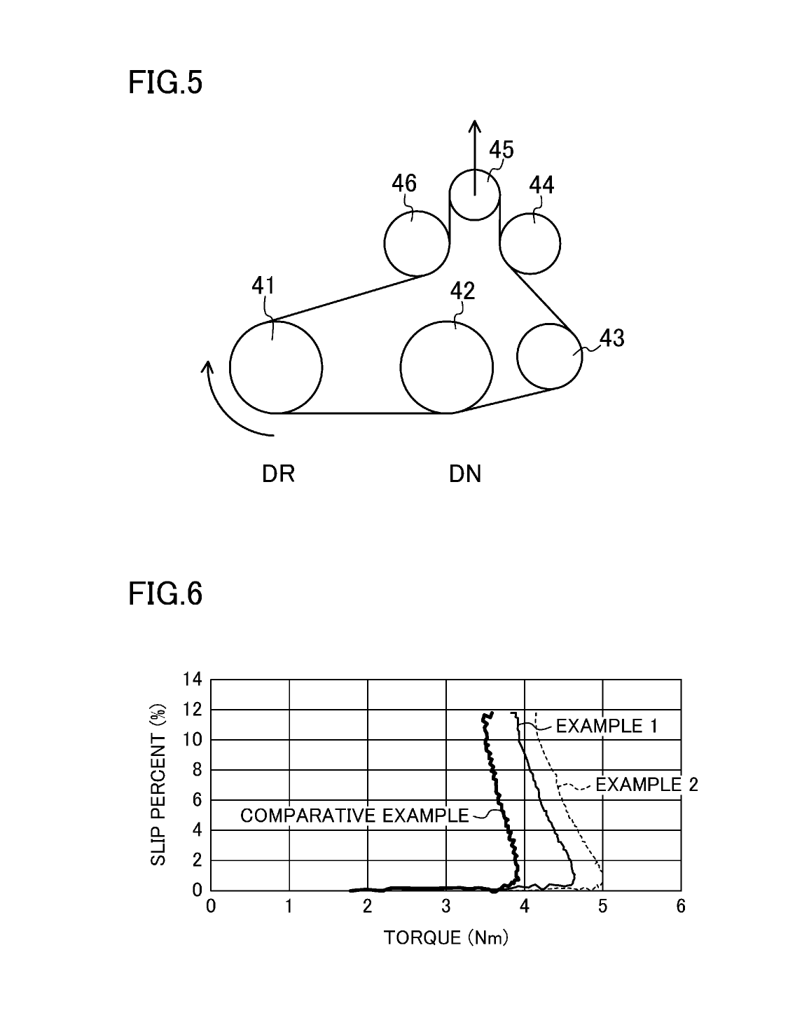

FIG. 5 illustrates a layout of pulleys of a belt running test machine 40 used in a transmission performance test under a wet condition.

The belt running test machine 40 includes: a driving pulley 41 (i.e. a ribbed pulley) having a pulley diameter of 121.6 mm; a driven pulley 42 (i.e. a ribbed pulley) provided to the right of the driving pulley 41 and having a pulley diameter of 121.6 mm; a driven pulley 43 (i.e. a ribbed pulley) provided to the upper right of the driven pulley 42 and having a pulley diameter of 77.0 mm; and a driven pulley 45 (i.e. a ribbed pulley) provided to the upper left of the driven pulley 43 and having a pulley diameter of 61.0 mm. Furthermore, the belt running test machine 40 includes: an idler pulley 44 (i.e. a flat-belt pulley) provided between the driven pulley 43 and the driven pulley 45 and having a pulley diameter of 76.2 mm; and an idler pulley 46 (i.e. a flat-belt pulley) provided between the driven pulley 45 and the driving pulley 41, and having a pulley diameter of 76.2 mm. On the belt running test machine 40, the ribs of the V-ribbed belt make contact with the ribbed pulleys, namely the driving pulley 41, and the driven pulleys 42, 43, and 45; simultaneously, the back surface of the V-ribbed belt makes contact with the flat-belt pulleys, namely the idler pulleys 44 and 46.

The test conditions were the following: a belt tension of 180N at the driven pulley 45, a pulley speed of 800 rpm, a pulley wrap angle of 45°, an amount of water to be fed of 300 ml/min, and an ambient temperature of 21° C. FIG. 6 shows the results of the tests.

As illustrated in FIG. 6, the observed torque is higher in Examples 1 and 2 than in Comparative Example. In Example 1, 30 parts by mass of montmorillonite is mixed into 100 parts by mass of rubber, and in Example 2, 50 parts by mass of montmorillonite is mixed with 100 parts by mass of rubber; whereas, in Comparative Example, no montmorillonite is mixed with compressed rubber layer 11. Moreover, the observed torque is higher in Example 2 than in Example 1 because the amount of mixed montmorillonite is greater in Example 2. Specifically, any of Examples 1 and 2 and Comparative Example show the highest torque when the slip percent is approximately 1%. The highest torque in Example 2, Example 1, and Comparative Example is approximately 5 Nm, 4.7 Nm, and 3.9 Nm, respectively.

Note that when the montmorillonite is replaced with magnesium carbonate, the torque observed in Examples 1 and 2 was higher than that observed in Comparative Example. Here, the V-ribbed belt was made of rubber composition 1 in Table 1 with montmorillonite replaced with magnesium carbonate. The relationship between the amount of the magnesium carbonate mixed into rubber composition and its effect was substantially the same as that observed when the montmorillonite was mixed as seen in FIG. 6.

A friction transmission belt in the present disclosure may maintain excellent transmission performance when wet, and is particularly useful under a possibly wet condition.

What is claimed is:

1. A friction transmission belt looped over a pulley and transmits power, the friction transmission belt comprising:
a belt body made of a rubber composition in which at least one of montmorillonite or magnesium carbonate is mixed; and
a fabric layer configured to coat at least a surface, of the belt body, making contact with the pulley, wherein
the fabric layer has a portion making contact with at least one of the montmorillonite or the magnesium carbonate mixed into the rubber composition.

2. The friction transmission belt of claim 1, wherein
the fabric layer is a woven fabric or a knitted fabric, and
the fabric layer has a portion embedded in the rubber composition included in the belt body.

3. The friction transmission belt of claim 2, wherein
the woven fabric or the knitted fabric absorbs water.

4. The friction transmission belt of claim 1,
the friction transmission belt being made of a product including a rubber layer for forming the friction transmission belt and a fabric wrapped over the rubber layer, the product being pressed against a mold and simultaneously crosslinked to be the friction transmission belt, and the mold has a ribbed part to shape the surface of the belt body making contact with the pulley.
